(19) United States
(12) Patent Application Publication
(10) Pub. No.: US 2008/0020217 A1
(43) Pub. Date: Jan. 24, 2008

(54) Colorless Transparent Polyimide Composite Film and Method for Producing Same

(76) Inventors: Takashi Makinoshima, Kanagawa (JP); Shuta Kihara, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/629,989

(22) PCT Filed: Jun. 21, 2005
(86) PCT No.: PCT/JP05/11378

§ 371 Date: Dec. 19, 2006

(30) Foreign Application Priority Data
Jun. 21, 2004 (JP) 2004-181961

(51) Int. Cl. C08L 79/08; C08J 5/18; C08K 3/34; C08K 9/04

(52) U.S. Cl. 428/473.5; 264/13

(57) ABSTRACT

The present invention provides a colorless, transparent polyimide composite film containing a polyimide (A) having a specific repeating unit, and an organic-treated layered silicate (B) obtained through treatment with an organic onium ion having a specific structure such that the organic-treated layered silicate (B) is dispersed in the polyimide (A); and as well a method for producing a colorless, transparent polyimide composite film, the method including forming a film-form mixture through extrusion or application, onto a support, of a three-component liquid mixture containing the polyimide (A), the organic-treated layered silicate (B), and an organic solvent (C) having a specific SP value; and subsequently removing the organic solvent (C) from the film-form mixture. The polyimide composite film of the present invention is a colorless, transparent film containing the polyimide (A) and the organic-treated layered silicate (B) which is very uniformly dispersed in the polyimide, exhibiting excellent heat resistance and mechanical properties, and exhibiting flexibility.

### TECHNICAL FIELD

The present invention relates to a colorless, transparent polyimide composite film containing a layered silicic acid salt (hereinafter referred to as a “layered silicate”) treated with an organic onium ion having a specific structure; and to a method for producing the composite film.

### BACKGROUND ART

Polyimide resin is a heat-resistant resin which is generally obtained through cyclization of a polyamic acid synthesized by condensation reaction between an aromatic tetracarboxylic anhydride and an aromatic diamine. By virtue of its molecular chain rigidity, resonance stabilization, and strong chemical bonding, polyimide resin exhibits excellent resistance to thermal decomposition, high resistance to chemical change (e.g., oxidation or hydrolysis), and excellent mechanical and electric properties. In addition, polyimide resin exhibits flexibility. Therefore, polyimide resin has been widely employed as films, coating agents, molding parts, and insulating materials in, for example, the electric, electronic, automotive, and aerospace industries. Meanwhile, an urgent requirement has arisen for technical development of a transparent, highly heat-resistant resin which exhibits flexibility, heat resistance, and mechanical strength, and which serves as a substitute for glass or ceramic material employed in display substrates of computers, cellular phones, etc. Colorless, transparent polyimide is a promising material which satisfies such a requirement.

In recent years, with rapid progress of high integration of semiconductor elements in the field of electronic materials, demand has arisen for a polyimide film having a small thickness, and exhibiting high-level thermal stability, hygroscopic stability, high gas-barrier property, and improved mechanical properties. In order to improve such physical properties, attempts have been made to achieve good dispersion of a layered silicate in a polyimide resin.

As a polyimide composite material containing a polyimide resin and a layered silicate dispersed therein, and a method for producing the composite material, there have been disclosed a polyimide composite material containing a polyimide and a layered silicate treated with an organic onium ion (hereinafter the layered silicate may be referred to as an “organic-treated layered silicate”), the silicate being dispersed in the polyimide, as well as a method for producing the composite material (see Patent Document 1). In the production method, a prepolymer film is formed from a liquid mixture containing a polyamic acid and an organic-treated layered silicate, followed by dehydration-cyclization of the polyamic acid through heating at high temperature, to thereby produce a polyimide composite film.

However, such film production through a thermal imidization process from a liquid mixture containing a polyamic acid and an organic-treated layered silicate requires a high temperature and a long period of time for causing imidization to proceed. In some cases, imidization is carried out at a temperature equal to or higher than the glass transition temperature of the resin. Therefore, this production method tends to cause a problem in that the layered silicate can migrate in the resin because of high fluidity of the resin resulting from high-temperature imidization, resulting in aggregation of the layered silicate and insufficient transparency of the film.

Thus, Patent Document 1 specifies a “polyimide composite material containing a polyimide and a layered silicate treated with an organic onium ion, the silicate being dispersed in the polyimide.” However, specifically disclosed is a polyimide composition material containing an organic-treated layered silicate of poor dispersibility and exhibiting insufficient transparency.

In addition, a composite material which is specifically described in Patent Document 1; i.e., a composite material employing a polyimide formed from an aromatic tetracarboxylic anhydride, exhibits insufficient water-vapor-barrier property.

Meanwhile, there has been disclosed a method in which imidization is carried out through addition of a dehydrating agent containing a carboxylic anhydride and an amine to a liquid mixture of a polyamic acid and a layered silicate (see Patent Document 2). In this method, after a prepolymer film is formed through casting of the liquid mixture, volatilization of a solvent and imidization are carried out simultaneously, since the resultant polyimide exhibits solvent insolubility. Therefore, this method poses problems in that the resultant film is prone to exhibit poor surface smoothness due to formation of “fish eyes,” irregularities, etc. on the film surface, the film exhibits poor moldability, and the thickness of the film is difficult to control. In addition, disadvantageously, the film is not applicable to optical devices requiring a colorless, transparent film, since the polyimide per se assumes a brownish-red color.

Similar to the case of the composite material described in Patent Document 1, a composite material which is specifically described in Patent Document 2; i.e., a composite material employing a polyimide formed from an aromatic tetracarboxylic anhydride, exhibits insufficient water-vapor-barrier property.

Patent Document 1: Japanese Patent Application Laid-Open (kokai) No. H04-33955

Patent Document 2: Japanese Patent Application Laid-Open (kokai) No. 2000-302867

### DISCLOSURE OF THE INVENTION

In order to solve the aforementioned problems involved in conventionally employed polyimide composite films and production methods therefor, an object of the present invention is to provide a colorless, transparent polyimide composite film containing an organic-treated layered silicate of good dispersibility, exhibiting excellent heat resistance and mechanical properties, having considerably improved water-vapor-barrier property, and exhibiting flexibility. Another object of the present invention is to provide a method for producing the composite film.

Specifically, the present invention contemplates provision of a polyimide composite film which solves a problem involved in conventional polyimide films (i.e., coloring), and which is useful as a substitute for a glass or ceramic material employed in display substrates of computers, cellular phones, etc., or as a transparent, highly heat-resistant film which exhibits flexibility, heat resistance, and mechanical strength; and as well a method for producing the composite film.

In order to achieve the aforementioned objects, the present inventors have conducted extensive studies, and as a result have found that the objects can be achieved by provision of a polyimide composite film containing a polyimide (A) having a specific repeating unit, and an organic-treated layered silicate (B) obtained through treatment with an organic onium ion having a specific structure such that the organic-treated layered silicate (B) is dispersed in the polyimide (A); and a method for producing the composite film. The present invention has been accomplished on the basis of this finding. Accordingly, the present invention provides:

[1] a colorless, transparent polyimide composite film comprising a polyimide (A) having a repeating unit represented by the following formula (1), and an organic-treated layered silicate (B) obtained through treatment with an organic onium ion represented by the following formula (2) or (3), the organic-treated layered silicate (B) being dispersed in the polyimide (A);
formula (1) being represented by: 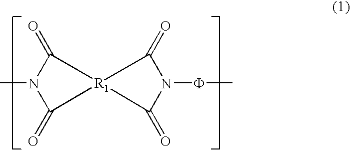
wherein R₁ represents a C5-C16 tetravalent chain or cyclic aliphatic hydrocarbon group; and Φ represents a C2-C28 divalent aliphatic hydrocarbon group or a C6-C27 divalent aromatic hydrocarbon group;
formula (2) being represented by: 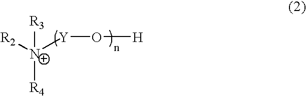
wherein Y represents a C1-C3 alkylene group; R₂, R₃, and R₄ each represent a C1-C18 alkyl group or a hydrogen atom; the total number of carbon atoms of R₂ to R₄ is 10 or more; and n represents an integer of 1 to 25; and
formula (3) being represented by: 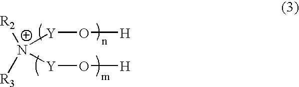
wherein Y represents a C1-C3 alkylene group; R₂ and R₃ each represent a C1-C18 alkyl group or a hydrogen atom; the total number of carbon atoms of R₂ and R₃ is 10 or more; n represents an integer of 1 to 25; m represents an integer of 1 to 25; and n+m is an integer of 2 to 50; and
[2] a method for producing a colorless, transparent polyimide composite film, the method comprising forming a film-form mixture through extrusion or application, onto a support, of a three-component liquid mixture containing a polyimide (A) having a repeating unit represented by the following formula (1), an organic-treated layered silicate (B) obtained through treatment with an organic onium ion represented by the following formula (2) or (3), and an organic solvent (C) having an SP value of 9.8 to 12.7 and containing at least one structure selected from the group consisting of a cyclic ether, a cyclic ketone, an ester, an amide, and urea; and subsequently removing the organic solvent (C) from the film-form mixture, the following conditions (I) to (III) being satisfied:

(I) the organic-treated layered silicate (B) is employed in such an amount that a two-component liquid mixture of the organic-treated layered silicate (B) and the organic solvent (C) has a haze of less than 50%;

(II) the amount of the organic-treated layered silicate (B) is 1 part by weight or more and less than 20 parts by weight on the basis of 100 parts by weight of the polyimide (A); and

(III) the organic solvent (C) is employed in such an amount that the amount of the polyimide (A) is 1 part by weight or more on the basis of 100 parts by weight of the organic solvent (C);
formula (1) being represented by: 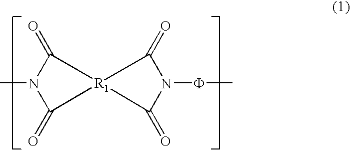
wherein R₁ represents a C5-C16 tetravalent chain or cyclic aliphatic hydrocarbon group; and Φ represents a C2-C28 divalent aliphatic hydrocarbon group or a C6-C27 divalent aromatic hydrocarbon group;
formula (2) being represented by: 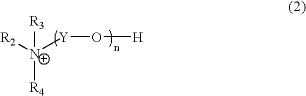
wherein Y represents a C1-C3 alkylene group; R₂, R₃, and R₄ each represent a C1-C18 alkyl group or a hydrogen atom; the total number of carbon atoms of R₂ to R₄ is 10 or more; and n represents an integer of 1 to 25; and
formula (3) being represented by: 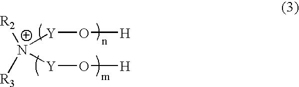
wherein Y represents a C1-C3 alkylene group; R₂ and R₃ each represent a C1-C18 alkyl group or a hydrogen atom; the total number of carbon atoms of R₂ and R₃ is 10 or more; n represents an integer of 1 to 25; m represents an integer of 1 to 25; and n+m is an integer of 2 to 50.

In the polyimide composite film production method of the present invention, an organic-treated layered silicate is swollen and dispersed finely and uniformly in a polyimide solution containing a specific solvent, and the resultant dispersion is subjected to a known casting process, to thereby form a film. Therefore, the polyimide composite film of the present invention is a colorless, transparent film containing the polyimide (A) and the organic-treated layered silicate (B) which is very uniformly dispersed in the polyimide, exhibiting excellent heat resistance and mechanical properties, and exhibiting flexibility.

### BEST MODES FOR CARRYING OUT THE INVENTION

The colorless, transparent polyimide composite film of the present invention contains a polyimide (A) having a repeating unit represented by formula (1), and an organic-treated layered silicate (B) obtained through treatment with an organic onium ion represented by formula (2) or (3). The colorless, transparent polyimide composite film production method of the present invention includes forming a film-form mixture through extrusion or application, onto a support, of a three-component liquid mixture containing the polyimide (A), the organic-treated layered silicate (B), and an organic solvent (C) having a specific SP value; and subsequently removing the organic solvent (C) from the film-form mixture.

The polyimide (A) employed in the present invention, which has a repeating unit represented by formula (1), is obtained through reaction between an aliphatic tetracarboxylic acid or a derivative thereof and a diamine.

Examples of the aliphatic tetracarboxylic acid or a derivative thereof include aliphatic tetracarboxylic acids, aliphatic tetracarboxylic acid esters, and aliphatic tetracarboxylic dianhydrides. Aliphatic tetracarboxylic dianhydrides are preferred. The diamine may be an aliphatic diamine or an aromatic diamine, or may be a mixture of these diamines.

Examples of aliphatic tetracarboxylic dianhydrides include 1,2,4,5-cyclopentanetetracarboxylic dianhydride, 1,2,4,5-cyclohexanetetracarboxylic dianhydride, and bicyclo[2.2.2]oct-7-ene-2,3,5,6-tetracarboxylic dianhydride. Of these, 1,2,4,5-cyclohexanetetracarboxylic dianhydride is particularly preferably employed. These aliphatic tetracarboxylic dianhydrides may be employed singly or in combination of two or more species. More preferably, 1,2,4,5-cyclohexanetetracarboxylic dianhydride is employed singly.

Examples of the aliphatic diamine include 4,4-diaminodicyclohexylmethane, isophoronediamine, ethylenediamine, tetramethylenediamine, norbornanediamine, p-xylylenediamine, 1,3-bis(aminomethyl)cyclohexane, 1,3-diaminocyclohexane, hexamethylenediamine, polyethylene glycol bis(3-aminopropyl)ether, m-xylylenediamine, 4,4-methylenebis(cyclohexylamine), bicyclohexyldiamine, and siloxanediamines. These diamines may be employed singly or in combination of two or more species. Of these, diamines having an alicyclic structure (e.g., 4,4-diaminodicyclohexylmethane, isophoronediamine, and 1,3-diaminocyclohexane) are preferably employed, from the viewpoints of easy polymerization and excellent heat resistance. Such diamines may be employed singly or in combination of two or more species.

Examples of the aromatic diamine include oxydianiline, diaminodiphenylmethane, 1,3-phenylenediamine, 1,4-phenylenediamine, dimethylbenzidine, dimethoxybenzidine, diaminodiphenyl sulfide, diaminodiphenyl sulfoxide, diaminodiphenylsulfone, diaminobenzophenone, 2,2-bis(3-aminophenyl)propane, 2,2-bis(4-aminophenyl)propane, 2,2-bis[4-(4-aminophenoxy)phenyl]-1,1,1,3,3,3-hexafluoropropane, 1,4-bis(3-aminophenoxy)benzene, 1,4-bis(4-aminophenoxy)benzene, 1,3-bis(3-aminophenoxy)benzene, 1,3-bis(4-aminophenoxy)benzene, 4,4-bis(3-aminophenoxy)biphenyl, 4,4-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]ether, and bis[4-(4-aminophenoxy)phenyl]ether. These diamines may be employed singly or in combination of two or more species.

Among the polyimides (A) which may be employed in the present invention, particularly preferred is a polyimide having a repeating unit represented by the following formula (4): 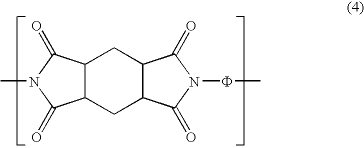
(wherein Φ represents a C2-C28 divalent aliphatic hydrocarbon group or a C6-C27 divalent aromatic hydrocarbon group).

The organic solvent (C) employed in the colorless, transparent polyimide composite film production method of the present invention has an SP (solubility parameter) value of 9.8 to 12.7, and contains at least one structure selected from the group consisting of a cyclic ether, a cyclic ketone, a cyclic ester, an amide, and urea. The organic solvent is preferably, a polar aprotic organic solvent such as γ-butyrolactone, N,N-dimethylacetamide, N,N-dimethylformamide, N-methyl-2-pyrrolidone, dimethyl sulfoxide, hexamethylphosphoramide, cyclopentanone, cyclohexanone, 1,3-dioxolane, 1,4-dioxane, tetramethylurea, or tetrahydrofuran. Of these, more preferred is one or more species selected from the group consisting of γ-butyrolactone, N,N-dimethylacetamide, N,N-dimethylformamide, and N-methyl-2-pyrrolidone.

The layered silicate; i.e., the raw material of an organic-treated layered silicate (B) employed in the present invention, is a clay mineral which has cation exchangeability and is swollen through absorption of water between layers. Examples of such a layered silicate include smectite clays (e.g., montmorillonite, saponite, and hectorite), swellable mica, and chemically synthesized products, derivatives, and mixtures thereof. Of these, smectite clays are preferred, with montmorillonite and hectorite being particularly preferred. The layered silicate to be employed preferably has a cation exchangeability of about 100 to about 300 meq/100 g. A layered silicate having a cation exchangeability in excess of 300 meq/100 g exhibits excessively strong interlayer bonding force, and thus encounters difficulty in increasing spaces between layers. Therefore, such a layered silicate would exhibit low swellability in the aforementioned polar organic solvent, leading to insufficient dispersion of the layered silicate in polyimide. Meanwhile, in the case where a layered silicate having a cation exchangeability of less than 100 meq/100 g is employed, the amount of interlayer ion exchange with an organic onium ion would become insufficient, and the resultant silicate would exhibit low affinity for polyimide.

As used herein, “organic-treated layered silicate (B)” refers to a layered silicate containing an organic onium ion, which is obtained through treatment with the organic onium ion. The organic onium ion employed in the present invention includes at least one alkylene oxide structure, and is represented by formula (2) or (3). The layered silicate employed in the invention must be treated with an organic onium ion which is represented by formula (2) or (3) and which includes an alkylene oxide structure in its main chain, in order to promote layer exfoliation of the layered silicate in the aforementioned organic solvent (C), and to improve dispersibility of the layered silicate in a polyimide composite film for preventing reaggregation of the layered silicate due to thermal treatment, the polyimide composite film being obtained by forming a film-form mixture through extrusion or application, onto a support, of a liquid mixture containing three components (i.e., the aforementioned polyimide (A), organic-treated layered silicate (B), and organic solvent (C)), followed by removal of the organic solvent (C) from the film-form mixture through drying.

In the case of an organic onium ion represented by formula (2), the amount (mole) of added alkylene oxide is preferably 1 to 25, particularly preferably 4 to 25. In the case of an organic onium ion represented by formula (3), the amount (mole) of added alkylene oxide is preferably 2 to 50, particularly preferably 4 to 25. When the amount (mole) of added alkylene oxide exceeds 50, a problem arises in terms of stability during thermal treatment. The total number of carbon atoms of an alkyl group(s) of an organic onium ion represented by formula (2) or (3) is preferably at least 10, particularly preferably 12 or more. When the number of carbon atoms is less than 10, an increase in interlayer distance of the aforementioned organic-treated layered silicate is suppressed, and layer exfoliation of the layered silicate would fail to occur sufficiently in the aforementioned organic solvent (C). The hydrocarbon structure may partially include a cyclic structure or an unsaturated bond.

The aforementioned organic onium ion may be a secondary or tertiary ammonium ion which is respectively obtained through treatment, with an inorganic acid (e.g., hydrochloric acid), of a secondary or tertiary amino compound having an alkylene oxide or polyalkylene oxide structure. Alternatively, the organic onium ion may be a quaternary ammonium ion corresponding to a synthesized quaternary ammonium compound having an alkylene oxide or polyalkylene oxide structure. Preferably, the organic onium ion is obtained through treatment, with an inorganic acid (e.g., hydrochloric acid), of a secondary or tertiary amino compound having an alkylene oxide structure, from the viewpoint that such a compound is readily available from a variety of existing commercial products.

Specific examples of the aforementioned secondary or tertiary amino compound having an alkylene oxide structure in its main chain include hydroxyethyldecylamine, bis(hydroxyethyl)decylamine, hydroxymethyldecylamine, bis(hydroxymethyl)decylamine, hydroxypropylenedecylamine, bis(hydroxypropylene)decylamine, bis(hydroxyethyl)dodecylamine, hydroxymethyldodecylamine, bis(hydroxymethyl)dodecylamine, hydroxypropylenedodecylamine, bis(hydroxypropylene)dodecylamine, hydroxyethyloctadecylamine, bis(hydroxyethyl)octadecylamine, hydroxymethyloctadecylamine, bis(hydroxymethyl)octadecylamine, hydroxypropyleneoctadecylamine, and bis(hydroxypropylene)octadecylamine.

Examples of the secondary or tertiary amino compound having a polyalkylene oxide structure in its main chain include hydroxypolyoxyethylenedecylamine, bis(hydroxypolyoxyethylene)decylamine, hydroxypolyoxymethylenedecylamine, bis(hydroxypolyoxymethylene)decylamine, hydroxypolyoxypropylenedecylamine, bis(hydroxypolyoxypropylene)decylamine, hydroxypolyoxyethylenedodecylamine, bis(hydroxypolyoxyethylene)dodecylamine, hydroxypolyoxymethylenedodecylamine, bis(hydroxypolyoxymethylene)dodecylamine, hydroxypolyoxypropylenedodecylamine, bis(hydroxypolyoxypropylene)dodecylamine, hydroxypolyoxyethyleneoctadecylamine, bis(hydroxypolyoxyethylene)octadecylamine, hydroxypolyoxymethyleneoctadecylamine, bis(hydroxypolyoxymethylene)octadecylamine, hydroxypolyoxypropyleneoctadecylamine, and bis(hydroxypolyoxypropylene)octadecylamine.

Specific examples of the aforementioned quaternary ammonium compound having an alkylene oxide structure in its main chain include hydroxyethylhexyldiethylammonium chloride, hydroxyethyloctyldimethylammonium chloride, hydroxyethyldecyldimethylammonium chloride, hydroxyethyldodecyldimethylammonium chloride, hydroxyethyloctadecyldimethylammonium chloride, hydroxyethyloctyldiethylammonium chloride, hydroxyethyldecyldiethylammonium chloride, hydroxyethyldodecyldiethylammonium chloride, hydroxyethyloctadecyldiethylammonium chloride, hydroxyethyltrioctylammonium chloride, dihydroxyethylethyloctylammonium chloride, dihydroxyethylmethyldecylammonium chloride, dihydroxyethylmethyldodecylammonium chloride, dihydroxyethylmethyloctadecylammonium chloride, dihydroxyethyldioctylammonium chloride, dihydroxyethylethyldecylammonium chloride, dihydroxyethylethyldodecylammonium chloride, and dihydroxyethylethyloctadecylammonium chloride.

Examples of the quaternary ammonium compound having a polyalkylene oxide structure in its main chain include hydroxypolyoxyethylenehexyldiethylammonium chloride, hydroxypolyoxyethyleneoctyldimethylammonium chloride, hydroxypolyoxyethylenedecyldimethylammonium chloride, hydroxypolyoxyethylenedodecyldimethylammonium chloride, hydroxypolyoxyethyleneoctadecyldimethylammonium chloride, hydroxypolyoxyethyleneoctyldiethylammonium chloride, hydroxypolyoxyethylenedecyldiethylammonium chloride, hydroxypolyoxyethylenedodecyldiethylammonium chloride, hydroxypolyoxyethyleneoctadecyldiethylammonium chloride, hydroxypolyoxyethylenetrioctylammonium chloride, bis(hydroxypolyoxyethylene)ethyloctylammonium chloride, bis(hydroxypolyoxyethylene)methyldecylammonium chloride, bis(hydroxypolyoxyethylene)methyldodecylammonium chloride, bis(hydroxypolyoxyethylene)methyloctadecylammonium chloride, bis(hydroxypolyoxyethylene)dioctylammonium chloride, bis(hydroxypolyoxyethylene)ethyldecylammonium chloride, bis(hydroxypolyoxyethylene)ethyldodecylammonium chloride, and bis(hydroxypolyoxyethylene)ethyloctadecylammonium chloride.

No particular limitation is imposed on the method for treating a layered silicate with an organic onium ion. For example, the organic-treated layered silicate may be synthesized through the following procedure: a layered silicate (1 part by weight) and an organic onium ion (0.5 to 2 parts by weight) are mixed and stirred in one or more solvents (30 to 100 parts by weight) selected from among water, methanol, ethanol, and ethylene glycol at 20 to 60° C. for three hours or more, and subsequently the thus-produced precipitate is subjected to suction filtration and drying. Drying for removal of the aforementioned solvent(s) is preferably vacuum drying at 60 to 100° C. for about 24 hours, or freeze-drying.

Specifically, the polyimide composite film of the present invention is produced through a method including the following steps (1) to (3):

step (1): synthesizing a polyimide (A);

step (2): preparing a three-component liquid mixture containing the polyimide (A), an organic-treated layered silicate (B), and an organic solvent (C); and

step (3): forming a film-form mixture through extrusion or application of the liquid mixture onto a support, followed by removal of the organic solvent (C) from the film-form mixture, thereby producing a colorless, transparent polyimide composite film.

Firstly, in step (1), a solution of the polyimide (A) (solution A) is synthesized through dehydration-imidization between an aliphatic tetracarboxylic acid or a derivative thereof and a diamine in the organic solvent (C). Specifically, the solution A is obtained through the following procedure: an aliphatic tetracarboxylic acid or a derivative thereof is added to a solution of a diamine in the organic solvent (C); the resultant mixture is maintained at 4 to 30° C. to thereby prepare a polyamic acid solution; and an imidization catalyst is added to the solution, followed by dehydration-imidization with evaporation of the thus-generated water to the outside of the reaction system.

The imidization catalyst may be added before addition of the aliphatic tetracarboxylic acid or a derivative thereof. In such a case, a generally employed reaction condition for forming a polyamic acid; i.e., maintenance of a raw-material-containing mixture at a temperature in the vicinity of room temperature or lower, can be omitted, and heating of the mixture can be initiated immediately for dehydration-imidization.

The imidization catalyst to be employed may be a tertiary amine (e.g., triethylamine, n-tripropylamine, n-tributylamine, pyridine, or β-picoline) or an acid (e.g., phenol or benzoic acid), but is preferably a tertiary amine. The molar ratio of such an imidization catalyst to a diamine to be employed (i.e., imidization catalyst/diamine) is preferably 0.01 to 1.0, particularly preferably 0.05 to 0.1.

The molar ratio of the diamine employed in step (1) to the aliphatic tetracarboxylic acid or a derivative thereof employed in step (1) (i.e., diamine/aliphatic tetracarboxylic acid or derivative thereof) is preferably 0.95 to 1.05, particularly preferably 0.99 to 1.01.

In dehydration-imidization carried out in step (1), a distillate primarily containing water is discharged to the outside of the reaction system by means of a steam cooling tower mounted on the top of a reaction vessel and a distillate storage apparatus engaged with the cooling tower. The reaction temperature is generally 160 to 200° C., preferably 170 to 190° C., more preferably 180 to 190° C. When the reaction temperature is lower than 160° C., imidization and polymerization would fail to proceed completely due to insufficient temperature, whereas when the reaction temperature exceeds 200° C., problems would occur; for example, a considerable increase in solution viscosity causes sticking of resin to the inner wall of the reaction vessel. In some cases, an azeotropic dehydrating agent (e.g., toluene or xylene) may be employed. The reaction is generally carried out at ambient pressure, but, if necessary, the reaction may be carried out under pressurized conditions. The aforementioned reaction temperature must be maintained for at least one hour, and is more preferably three hours or more and 10 hours or less. When the maintenance time is less than one hour, imidization and polymerization would fail to proceed completely. Even when the maintenance time exceeds 10 hours, imidization and polymerization no longer proceed. The polymerization degree of the polyimide (A) can be relatively determined through measurement of logarithmic viscosity number of the polyimide (A). Logarithmic viscosity number is measured at 30° C. in a solution of the polyimide (A) in N-methyl-2-pyrrolidone (concentration: 0.5 g/dL). When the logarithmic viscosity number is less than 0.4 dL/g, the polyimide (A) exhibits insufficient polymerization degree, and is difficult to be formed into a self-standing film. The logarithmic viscosity number is preferably 0.8 dL/g or more.

In step (1), the concentration of the thus-obtained polyimide (A) is preferably 20 wt. % to 50 wt. %, particularly preferably 30 wt. % to 40 wt. %, on the basis of the total amount of the organic solvent (C) and the polyimide (A). When the polyimide concentration is less than 20 wt. %, the logarithmic viscosity number of the polyimide tends not to increase, whereas when the polyimide amount exceeds 50 wt. %, the viscosity of the polyimide solution would become excessively high at the time when the logarithmic viscosity number of the polyimide increases, and thus non-uniform stirring of a portion of the solution at the inner wall of the reaction vessel would cause sticking of resin to the inner wall.

Subsequently, in step (2), a three-component liquid mixture containing the polyimide (A), the organic-treated layered silicate (B), and the organic solvent (C) is prepared through any of the following processes (1) to (3):

process (1): a process in which a mixture containing the polyimide (A) and the organic solvent (C) is mixed under stirring with the organic-treated layered silicate (B);

process (2): a process in which the polyimide (A) is mixed under stirring with a mixture containing the organic-treated layered silicate (B) and the organic solvent (C); and

process (3): a process in which a mixture containing the polyimide (A) and a portion of the organic solvent (C) is mixed under stirring with a mixture containing the organic-treated layered silicate (B) and a portion of the organic solvent (C).

The polyimide (A) employed in process (2) is appropriately obtained through the following procedure: a solvent in which polyimide exhibits poor solubility (e.g., methanol) is added to the polyimide (A) solution prepared in the aforementioned step (1) to thereby precipitate the polyimide (A), and the thus-precipitated polyimide (A) is subjected to filtration, washing, and drying for separation of the polyimide (A) in the form of solid.

The mixture employed in process (1) or (3); i.e., a mixture containing the polyimide (A) and the organic solvent (C) or a mixture containing the polyimide (A) and a portion of the organic solvent (C), may be the polyimide (A) solution prepared in the aforementioned step (1) as it is. Alternatively, the mixture to be employed may be a solution prepared by re-dissolving, in the organic solvent (C), the polyimide (A) obtained through the following procedure: a solvent in which polyimide exhibits poor solubility (e.g., methanol) is added to the aforementioned polyimide (A) solution to thereby precipitate the polyimide (A), and the thus-precipitated polyimide (A) is subjected to filtration, washing, and drying for separation of the polyimide (A) in the form of solid.

The three-component liquid mixture containing the polyimide (A), the organic-treated layered silicate (B), and the organic solvent (C) is prepared through any of the aforementioned processes. In order that the organic-treated layered silicate (B) may be divided into individual layers and dispersed finely and uniformly in the liquid mixture, the liquid mixture must satisfy the following conditions (I) to (III):

(I) the organic-treated layered silicate (B) is employed in such an amount that a two-component liquid mixture of the organic-treated layered silicate (B) and the organic solvent (C) has a haze of less than 50%;

(II) the amount of the organic-treated layered silicate (B) is 1 part by weight or more and less than 20 parts by weight on the basis of 100 parts by weight of the polyimide (A); and

(III) the organic solvent (C) is employed in such an amount that the amount of the polyimide (A) is 1 part by weight or more on the basis of 100 parts by weight of the organic solvent (C).

When the aforementioned condition (I) is not satisfied; i.e., when the haze is 50% or more, layer exfoliation of the organic-treated layered silicate does not proceed sufficiently with the organic solvent (C), and thus the organic-treated layered silicate (B) exhibits poor dispersibility in the three-component liquid mixture containing the polyimide (A).

When the aforementioned condition (II) is not satisfied; i.e., when the amount of the organic-treated layered silicate (B) is less than 1 part by weight on the basis of 100 parts by weight of the polyimide (A), properties of the resultant film are not improved. In contrast, when the amount of the organic-treated layered silicate (B) is 20 parts by weight or more on the basis of 100 parts by weight of the polyimide (A), the layered silicate partially aggregates, which may cause haze and considerable reduction of toughness. The amount of the organic-treated layered silicate (B) is preferably 1 to 15 parts by weight on the basis of 100 parts by weight of the polyimide (A).

When the aforementioned condition (III) is not satisfied; i.e., when the organic solvent (C) is employed in such an amount that the amount of the polyimide (A) is less than 1 part by weight on the basis of 100 parts by weight of the organic solvent (C), the ratio of the polyimide (A) to the organic solvent (C) becomes excessively low, the viscosity of the three-component liquid mixture becomes low, and thus a film-form mixture is difficult to form in the subsequent step (3). In addition, removal of the organic solvent (C) requires a long period of time, and productivity is reduced. Preferably, the organic solvent (C) is employed in such an amount that the amount of the polyimide (A) is 10 to 20 parts by weight on the basis of 100 parts by weight of the organic solvent (C).

Subsequently, in step (3), the liquid mixture prepared in step (2); i.e., the three-component mixture containing the polyimide (A), the organic-treated layered silicate (B), and the organic solvent (C), is extruded or applied onto a support (e.g., a glass substrate or a stainless steel substrate) to thereby form a film-form mixture, and subsequently the film-form mixture is dried on a hot plate or in a drying furnace at 120° C. or lower for about 30 to 60 minutes for removal of the organic solvent (C) until the thus-dried film-form mixture exhibits self-supportability. Subsequently, the film-form mixture is removed from the support, and both end portions of the film-form mixture is fixated. Thereafter, while shrinkage of the film-form mixture is suppressed, the film-form mixture is heated to at least the boiling point of the organic solvent (C) (preferably, to a temperature higher by 5 to 10 degrees (in Celsius) than the boiling point) over one hour so as to prevent bumping of the remaining organic solvent (C), followed by vacuum drying at the same temperature, to thereby yield a polyimide composite film.

The time required for vacuum drying varies with the thickness of the film. In order to regulate the amount of the solvent remaining in a thick film (thickness: 150 to 200 μm) which is to be employed as a plastic substrate for a flexible display to less than 1%, vacuum drying is preferably carried out for at least five hours, more preferably eight hours or more.

In the aforementioned step (3), extrusion or application (for film formation) of the three-component liquid mixture containing the polyimide (A), the organic-treated layered silicate (B), and the organic solvent (C) onto a support (e.g., a glass substrate or a stainless steel substrate) may be carried out through any film formation technique, such as a known dry molding or dry-wet molding technique. Examples of such a film formation technique include a casting technique employing die extrusion, and a technique employing an applicator, a coater, or a similar apparatus. The aforementioned support may be a film formed of an organic polymer (e.g., polyethylene terephthalate or polyethylene naphthalate).

In any of the aforementioned production steps, a surfactant, an internal mold release agent, or the like may be added to the polyimide composite film of the present invention for the purpose of improving properties (e.g., surface smoothness and mold releasability).

The polyimide composite film of the present invention is applicable to optical devices (e.g., a flexible display substrate and an optical sensor), and requires colorlessness and transparency. For example, when the composite film has a thickness of 100 μm, the film must be evaluated as being colorless and transparent through visual observation. When having a thickness of 100 μm, the composite film preferably has a total light transmittance of 86% or more, particularly preferably 88% or more, more preferably 90% or more. When having a thickness of 100 μm, the composite film preferably has a haze of less than 2%, particularly preferably less than 1.5%.

In the case where the polyimide composite film is applied to a liquid crystal or organic EL display substrate or a solar battery substrate, such a substrate is required to have heat resistance to at least 300° C., since, in the production process for a thin-film transistor serving as a drive element, an amorphous silicon film employed in a semiconductor layer is formed at a high temperature of 250° C. or higher. The higher the film formation temperature, the more improved the properties of the silicon film. When a transparent, electrically conductive thin film formed of, for example, indium oxide, indium-tin composite oxide, or zinc oxide is provided, as a transparent electrode, on the aforementioned display substrate or solar battery substrate, the substrate is required to have heat resistance to at least 200° C. (preferably, heat resistance to 300° C. or higher) from the viewpoints of enhancement of the crystallization degree of the transparent, electrically conductive thin film and reduction of the surface resistance of the film. The higher the film formation temperature, the more improved the properties of the transparent, electrically conductive thin film.

When the polyimide composite film of the present invention is applied to the aforementioned display substrate, a gas-barrier film must be formed on the composite film through vapor deposition, and thus the composite film is required to have heat resistance to at least 200° C. The polyimide composite film preferably has heat resistance to 300° C. or higher, from the viewpoint of formation of a high-density gas-barrier film on the composite film through firing. The higher the firing temperature, the more improved the gas-barrier property of the gas-barrier film. When the polyimide composite film has a moisture permeation coefficient of 20 g·mm/m2·day or more, vacuum level is insufficiently increased during the course of vapor deposition, which causes problems. The moisture permeation coefficient of the polyimide composite film is preferably 5 g·mm/m2·day or less, more preferably 3 g·mm/m2·day or less. No particular limitation is imposed on the mechanical strength of the polyimide composite film, but a high mechanical strength value is preferred.

### EXAMPLES

The present invention will next be described in detail by way of Examples, which should not be construed as limiting the invention thereto.

Physical properties of polyimides, two-component liquid mixtures (each containing an organic-treated layered silicate and an organic solvent), and polyimide composite films obtained in Examples and Comparative Examples were measured through the below-described methods.

<Evaluation Method for Polyimide>

<Measurement of Logarithmic Viscosity Number>.

A polyimide (0.1 g) was dissolved in N-methyl-2-pyrrolidone (20 mL), and logarithmic viscosity number of the polyimide was measured at 30° C. by means of a Canon-Fenske viscometer. Logarithmic viscosity number (μ) was calculated by use of the following formula.

μ=[ln(tₛ/t₀)]/C

t₀: solvent flow time

tₛ: dilute polymer solution flow time

C: 0.5 g/dL

<Evaluation Method for Two-Component Liquid Mixture Containing Organic-Treated Layered Silicate and Organic Solvent>

<Total Light Transmittance and Haze>

Haze of a two-component liquid mixture containing an organic-treated layered silicate and an organic solvent was obtained as an index for evaluating colorlessness and transparency according to “JIS K7105 transparency test method.” Specifically, a two-component liquid mixture is collected in a quartz cell having an optical path length of 1 cm, and haze of the liquid mixture was measured by means of a color difference/turbidity meter (COI-300A, product of Nippon Denshoku Industries Co., Ltd.). Total light transmittance and haze of a polyimide composite film were obtained by means of the aforementioned apparatus in a manner similar to that described above.

<Evaluation Method for Polyimide Composite Film>

<Measurement of Ash Content>

The amount of an inorganic substance contained in a polyimide composite film, the inorganic substance being derived from a layered silicate, was obtained according to JIS K7052. Specifically, the polyimide composite film was heated at 950° C. for two hours, and the weight of the inorganic substance contained in the composite film was measured.

<Glass Transition Temperature>

By means of a differential thermal analyzer (model: DSC-40M, product of Shimadzu Corporation), a polyimide composite film was heated to 400° C. at 10° C./minute in a nitrogen atmosphere, and glass transition temperature (hereinafter abbreviated as “T_{g}”) of the composite film was measured.

<Tensile Strength>

A dynamic property (tensile strength at break) of a polyimide composite film was measured according to ASTM D882-88 by means of Strograph V1-C (product of Toyo Seiki Seisaku-Sho, Ltd.).

<Moisture Permeation Coefficient>

Moisture permeation coefficient of a polyimide composite film was calculated on the basis of measurement of moisture permeability of the film according to “JIS K7129.”

Moisture permeability: measured at 40° C./90% RH by means of a water vapor permeability measuring apparatus (L80-4005L, product of LYSSY AG ZLLIKON).

### Referential Example

### Synthesis of 1,2,4,5-cyclohexanetetracarboxylic dianhydride

Pyromellitic acid (552 g), an Rh-on-activated carbon catalyst (product of N.E. Chemcat Corporation) (200 g), and water (1,656 g) were charged into a Hastelloy (HC22) autoclave (inner volume: 5 L), and the atmosphere in the reaction vessel was replaced by hydrogen gas under stirring so that the hydrogen pressure of the reaction vessel was 5.0 MPa, followed by heating to 60° C. While the hydrogen pressure was maintained at 5.0 MPa, reaction was allowed to proceed for two hours. The hydrogen gas contained in the reaction vessel was replaced by nitrogen gas, and the resultant reaction mixture was removed from the autoclave. The reaction mixture was filtered for separation of the catalyst. The filtrate was concentrated through removal of water under reduced pressure by means of a rotary evaporator, to thereby precipitate crystals. The thus-precipitated crystals were subjected to solid-liquid separation at room temperature, followed by drying, to thereby yield 481 g of 1,2,4,5-cyclohexanetetracarboxylic acid (yield: 85.0%). Subsequently, the thus-obtained 1,2,4,5-cyclohexanetetracarboxylic acid (481 g) and acetic anhydride (4,000 g) were charged into a 5-L glass separable flask, and the atmosphere in the reaction vessel was replaced by nitrogen gas under stirring. The resultant mixture was heated to the reflux temperature of the solvent in a nitrogen gas atmosphere, followed by reflux of the solvent for 10 minutes. The resultant reaction mixture was cooled to room temperature under stirring, to thereby precipitate crystals. The thus-precipitated crystals were subjected to solid-liquid separation, followed by drying, to thereby yield primary crystals. The thus-separated mother liquid was concentrated under reduced pressure by means of a rotary evaporator, to thereby precipitate crystals. The thus-precipitated crystals were subjected to solid-liquid separation, followed by drying, to thereby yield secondary crystals. The primary crystals and the secondary crystals were collected together, to thereby yield 375 g of 1,2,4,5-cyclohexanetetracarboxylic dianhydride (anhydride yield: 96.6%).

### Production Example 1

### Synthesis of Polyimide (A1)

Oxydianiline (20.12 g, 0.1 mol), and organic solvents; i.e., γ-butyrolactone (51.65 g) having an SP value of 12.6 and N,N-dimethylacetamide (12.92 g) having an SP value of 10.8, were charged into a 500-mL five-necked flask equipped with a thermometer, a stirrer, a nitrogen-introducing tube, and a condenser having a fractionator, followed by dissolution of oxydianiline in the organic solvents. The resultant solution was cooled to 5° C. by means of an ice-water bath. While the solution was maintained at the same temperature, 1,2,4,5-cyclohexanetetracarboxylic dianhydride (22.62 g, 0.1 mol) and triethylamine (0.50 g, 0.005 mol) serving as an imidization catalyst were added together to the solution. After completion of addition, the resultant mixture was heated to 180° C., and subjected to reflux for three hours while a distillate was removed as needed, followed by heating to 200° C. for completion of reaction. After air cooling was performed until the internal temperature became 100° C., N,N-dimethylacetamide (107.6 g) serving as a dilution solvent was added to the reaction mixture, followed by cooling under stirring, to thereby yield a polyimide solution (solution A1) (concentration: 20 wt. %). The weight of the polyimide solution was found to be 205.26 g, and the total weight of the distillate was found to be 3.66 g. A portion of the polyimide solution was poured into methanol (1 L) for polymer precipitation, and the polymer was subjected to filtration and washing with methanol, followed by drying in a vacuum dryer at 100° C. for 24 hours, to thereby yield white powder (polyimide (A1)). The IR spectrum of the powder showed absorption peaks at 1,706 cm⁻¹ and 1,766 cm⁻¹, which are specific to an imido group. Logarithmic viscosity number of the polyimide (A1) was measured, and was found to be 1.01.

### Production Example 2

### Synthesis of Polyimide (A2)

4,4-Diaminodicyclohexylmethane (21.14 g, 0.1 mol), and organic solvents; i.e., N-methyl-2-pyrrolidone (54.54 g) having an SP value of 11.3 and N,N-dimethylacetamide (13.60 g) having an SP value of 10.8, were charged into a 500-mL five-necked flask equipped with a thermometer, a stirrer, a nitrogen-introducing tube, and a condenser having a fractionator, followed by dissolution of 4,4-diaminodicyclohexylmethane in the organic solvents. The resultant solution was cooled to 5° C. by means of an ice-water bath. While the solution was maintained at the same temperature, 1,2,4,5-cyclohexanetetracarboxylic dianhydride (22.62 g, 0.1 mol) and triethylamine (0.50 g, 0.005 mol) serving as an imidization catalyst were added together to the solution. The resultant mixture was heated to 130° C. and stirred for about 30 minutes, whereby the thus-generated salt lumps were uniformly dissolved therein. Thereafter, the resultant solution was heated to 180° C., and subjected to reflux for six hours while a distillate was removed as needed, followed by heating to 200° C. for completion of reaction. Thereafter, air cooling was performed until the internal temperature became 100° C. N,N-dimethylacetamide (113.4 g) serving as a dilution solvent was added to the reaction mixture, followed by cooling under stirring, to thereby yield a polyimide solution (solution A2) (concentration: 20 wt. %). The weight of the polyimide solution was found to be 223.82 g, and the total weight of the distillate was found to be 3.54 g. A portion of the polyimide solution was poured into methanol (1 L) for polymer precipitation, and the polymer was subjected to filtration and washing with methanol, followed by drying in a vacuum dryer at 100° C. for 24 hours, to thereby yield white powder (polyimide (A2)). The IR spectrum of the powder showed absorption peaks at 1,691 cm⁻¹ and 1,764 cm⁻¹, which are specific to an imido group. Logarithmic viscosity number of the polyimide (A2) was measured, and was found to be 0.86.

### Example 1

### Preparation of Organic-Treated Layered Silicate (D1)

Bis(hydroxypolyoxyethylene)octadecylamine (product name: Nymeen S204, amount (mole) of added ethylene oxide: 4, product of NOF Corporation) (12.73 g) and concentrated hydrochloric acid (4.8 mL) were dissolved in distilled water (100 mL), followed by stirring at an internal temperature of 80° C., to thereby yield an ammonium salt of bis(hydroxypolyoxyethylene)octadecylamine. Separately, swellable montmorillonite (product name: Kunipia P, product of Kunimine Industries Co., Ltd.) (20 g) was added to distilled water (500 mL), and was swollen and dispersed therein through ultrasonication for three hours. The resultant dispersion was mixed with the above-obtained ammonium salt, and the mixture was stirred at 80° C. for one hour, followed by filtration, washing with hot water (twice or more), and vacuum drying at 60° C. for 12 hours, to thereby yield montmorillonite treated with a bis(hydroxypolyoxyethylene)octadecylammonium ion (organic-treated layered silicate (D1)).

<Preparation of Two-Component Liquid Mixture (D11)>

The organic-treated montmorillonite (organic-treated layered silicate (D1)) (1 part by weight) was added to N,N-dimethylacetamide having an SP value of 10.8 (100 parts by weight), and the resultant mixture was stirred by means of a high-speed homogenizer (product name: Physcotron NS-51, product of Microtec Co., Ltd.) at 10,000 rpm for 20 minutes, to thereby yield an organic-treated montmorillonite dispersion (two-component liquid mixture (D11)). Haze of the two-component liquid mixture was measured by means of a color difference/turbidity meter, and was found to be 43.5%. The polyimide (A1) obtained in Production Example 1 was mixed with the two-component liquid mixture (D11) at 60° C. so that the amount of the organic-treated montmorillonite was 8 parts by weight on the basis of 100 parts by weight of the polyimide, and the resultant mixture was stirred by means of a high-speed homogenizer at 10,000 rpm for two hours. The thus-obtained three-component liquid mixture containing the polyimide, organic-treated layered silicate, and organic solvent was cast, by means of a doctor blade of 1,500 μm, onto a stainless steel substrate uniformly coated with a plastic mold release agent (Pelicoat). The mixture-cast substrate was maintained at 100° C. for 60 minutes by means of a hot plate for volatilization of the organic solvent, to thereby yield a colorless, transparent primary dry film exhibiting self-supportability. The film was fixated on a stainless steel frame, and then vacuum-dried at 200° C. for five hours for removal of the remaining organic solvent, to thereby yield a colorless, transparent polyimide composite film having a thickness of 117 μm. The ash content of the film was found to be 6.7%. Total light transmittance, haze, glass transition temperature, tensile strength, and moisture permeation coefficient of the film were measured. The results are shown in Table 1.

### Example 2

### Preparation of Organic-Treated Layered Silicate (D2)

Bis(hydroxypolyoxyethylene)dodecylamine (product name: Nymeen L207, amount (mole) of added ethylene oxide: 7, product of NOF Corporation) (14.10 g) and concentrated hydrochloric acid (4.8 mL) were dissolved in distilled water (100 mL), followed by stirring at an internal temperature of 80° C., to thereby yield an ammonium salt of bis(hydroxypolyoxyethylene) dodecylamine. Separately, swellable montmorillonite (product name: Kunipia P, product of Kunimine Industries Co., Ltd.) (20 g) was added to distilled water (500 mL), and was swollen and dispersed therein through ultrasonication for three hours. The resultant dispersion was mixed with the above-obtained ammonium salt, and the mixture was stirred at 80° C. for one hour, followed by filtration, washing with hot water (twice or more), and vacuum drying at 60° C. for 12 hours, to thereby yield montmorillonite treated with a bis(hydroxypolyoxyethylene)dodecylammonium ion (organic-treated layered silicate (D2)).

<Preparation of Two-Component Liquid Mixture (D21)>

The organic-treated montmorillonite (organic-treated layered silicate (D2)) (1 part by weight) was added to a solvent mixture (100 parts by weight) containing N,N-dimethylacetamide having an SP value of 10.8 (20 parts by weight) and γ-butyrolactone having an SP value of 12.6 (80 parts by weight), and the resultant mixture was stirred by means of a high-speed homogenizer (product name: Physcotron NS-51, product of Microtec Co., Ltd.) at 10,000 rpm for 20 minutes, to thereby yield an organic-treated montmorillonite dispersion (two-component liquid mixture (D21)). Haze of the two-component liquid mixture was measured by means of a color difference/turbidity meter, and was found to be 47.3%.

The procedure of Example 1 was repeated, except that the solution A1 obtained in Production Example 1 was mixed with the two-component liquid mixture (D21) at 60° C. so that the amount of the organic-treated montmorillonite was 8 parts by weight on the basis of 100 parts by weight of the polyimide, to thereby yield a polyimide composite film having a thickness of 122 μm. The ash content of the film was found to be 6.1%. Total light transmittance, haze, glass transition temperature, tensile strength, and moisture permeation coefficient of the film were measured. The results are shown in Table 1.

### Example 3

### Preparation of Two-Component Liquid Mixture (D31)

Organic-treated hectorite (product name: Lucentite SEN, amount (mole) of added ethylene oxide: 15, product of Co-op Chemical Co., Ltd.) (organic-treated layered silicate (D3)) (3 parts by weight), which had been obtained through treatment with a bis(hydroxypolyoxyethylene)-palm-oil-alkylmethylammonium ion, was added to a solvent mixture (100 parts by weight) containing N,N-dimethylacetamide having an SP value of 10.8 (20 parts by weight) and γ-butyrolactone having an SP value of 12.6 (80 parts by weight), and the resultant mixture was stirred by means of a high-speed homogenizer (product name: Physcotron NS-51, product of Microtec Co., Ltd.) at 10,000 rpm for 20 minutes, to thereby yield an organic-treated hectorite dispersion (two-component liquid mixture (D31)). Haze of the two-component liquid mixture was measured by means of a color difference/turbidity meter, and was found to be 8.4%.

The procedure of Example 1 was repeated, except that the organic-treated layered silicate (D3) was added to the solution A1 obtained in Production Example 1 so that the amount of the organic-treated hectorite was 15 parts by weight on the basis of 100 parts by weight of the polyimide; and that the resultant mixture was diluted and mixed at 60° C. with N,N-dimethylacetamide having an SP value of 10.8 (organic solvent (C)) so that, in the resultant three-component liquid mixture, the amount of the organic-treated layered silicate (D3) was 3 parts by weight on the basis of 100 parts by weight of the organic solvent (C) in the two-component liquid mixture of the organic solvent (C) and the organic-treated layered silicate (D3), to thereby yield a colorless, transparent polyimide composite film having a thickness of 112 μm. The ash content of the film was found to be 10.2%. Total light transmittance, haze, glass transition temperature, tensile strength, and moisture permeation coefficient of the film were measured. The results are shown in Table 1.

### Example 4

The procedure of Example 1 was repeated, except that the polyimide (A2) obtained in Production Example 2 was mixed with the two-component liquid mixture (D11) at 60° C. so that the amount of the organic-treated montmorillonite was 8 parts by weight on the basis of 100 parts by weight of the polyimide, to thereby yield a colorless, transparent polyimide composite film having a thickness of 115 μm. The ash content of the film was found to be 6.5%. Total light transmittance, haze, glass transition temperature, and tensile strength of the film were measured. The results are shown in Table 1.

### Example 5

The procedure of Example 1 was repeated, except that the solution A2 obtained in Production Example 2 was mixed with the two-component liquid mixture (D21) at 60° C. so that the amount of the organic-treated montmorillonite was 8 parts by weight on the basis of 100 parts by weight of the polyimide, to thereby yield a polyimide composite film having a thickness of 120 μm. The ash content of the film was found to be 6.0%. Total light transmittance, haze, glass transition temperature, tensile strength, and moisture permeation coefficient of the film were measured. The results are shown in Table 1.

### Example 6

The procedure of Example 1 was repeated, except that the organic-treated layered silicate (D3) was added to the solution A2 obtained in Production Example 2 so that the amount of the organic-treated hectorite was 15 parts by weight on the basis of 100 parts by weight of the polyimide; and that the resultant mixture was diluted and mixed at 60° C. with N,N-dimethylacetamide having an SP value of 10.8 (organic solvent (C)) so that, in the resultant three-component liquid mixture, the amount of the organic-treated layered silicate (D3) was 3 parts by weight on the basis of 100 parts by weight of the organic solvent (C) in the two-component liquid mixture of the organic solvent (C) and the organic-treated layered silicate (D3), to thereby yield a colorless, transparent polyimide composite film having a thickness of 116 μm. The ash content of the film was found to be 10.2%. Total light transmittance, haze, glass transition temperature, tensile strength, and moisture permeation coefficient of the film were measured. The results are shown in Table 1.

### Example 7

The procedure of Example 1 was repeated, except that the organic-treated layered silicate (D3) was added to the solution A2 obtained in Production Example 2 so that the amount of the organic-treated hectorite was 15 parts by weight on the basis of 100 parts by weight of the polyimide; and that the resultant mixture was diluted and mixed at 60° C. with N,N-dimethylformamide having an SP value of 12.1 (organic solvent (C)) so that, in the resultant three-component liquid mixture, the amount of the organic-treated layered silicate (D3) was 3 parts by weight on the basis of 100 parts by weight of the organic solvent (C) in the two-component liquid mixture of the organic solvent (C) and the organic-treated layered silicate (D3), to thereby yield a colorless, transparent polyimide composite film having a thickness of 110 μm. The total light transmittance and haze of the film were found to be 89.0% and 1.1%, respectively. The results are shown in Table 1.

### Comparative Example 1

The solution A1 was cast, by means of a doctor blade of 1,000 μm, onto a stainless steel substrate uniformly coated with a plastic mold release agent (Pelicoat). The solution-cast substrate was maintained at 100° C. for 60 minutes by means of a hot plate for volatilization of the solvent, to thereby yield a colorless, transparent primary dry film exhibiting self-supportability. The film was fixated on a stainless steel frame, and then vacuum-dried at 200° C. for five hours for removal of the remaining solvent, to thereby yield a colorless, transparent semi-aliphatic polyimide film having a thickness of 138 μm. Total light transmittance, haze, glass transition temperature, tensile strength, and moisture permeation coefficient of the film were measured. The results are shown in Table 1.

### Comparative Example 2

The solution A2 was cast, by means of a doctor blade of 1,000 μm, onto a stainless steel substrate uniformly coated with a plastic mold release agent (Pelicoat). The solution-cast substrate was maintained at 100° C. for 60 minutes by means of a hot plate for volatilization of the solvent, to thereby yield a colorless, transparent primary dry film exhibiting self-supportability. The film was fixated on a stainless steel frame, and then vacuum-dried at 200° C. for five hours for removal of the remaining solvent, to thereby yield a colorless, transparent total-aliphatic polyimide film having a thickness of 124 μm. Total light transmittance, haze, glass transition temperature, and tensile strength of the film were measured. The results are shown in Table 1.

### Comparative Example 3

The procedure of Example 1 was repeated, except that the solution A1 was mixed with the two-component liquid mixture (D11) at 60° C. so that the amount of the organic-treated montmorillonite was 25 parts by weight on the basis of 100 parts by weight of the polyimide, to thereby yield a partially turbid polyimide composite film having a thickness of 105 μm. The ash content of the film was found to be 20.4%. Total light transmittance, haze, glass transition temperature, tensile strength, and moisture permeation coefficient of the film were measured. The results are shown in Table 1.

### Comparative Example 4

The procedure of Example 1 was repeated, except that the solution A2 was mixed with the two-component liquid mixture (D11) at 60° C. so that the amount of the organic-treated montmorillonite was 25 parts by weight on the basis of 100 parts by weight of the polyimide, to thereby yield a partially turbid polyimide composite film having a thickness of 102 μm. The ash content of the film was found to be 19.7%. Total light transmittance, haze, glass transition temperature, and tensile strength of the film were measured. The results are shown in Table 1.

### Comparative Example 5

### Preparation of Organic-Treated Layered Silicate (D4)

Dodecylamine (product of Kanto Chemical Co., Inc.) (7.33 g) and concentrated hydrochloric acid (4.8 mL) were dissolved in distilled water (100 mL), followed by stirring at an internal temperature of 80° C., to thereby yield an ammonium salt of dodecylamine. Separately, swellable montmorillonite (product name: Kunipia P, product of Kunimine Industries Co., Ltd.) (20 g) was added to distilled water (500 mL), and was swollen and dispersed therein through ultrasonication for three hours. The resultant dispersion was mixed with the above-obtained ammonium salt, and the mixture was stirred at 80° C. for one hour, followed by filtration, washing with hot water (twice or more), and vacuum drying at 60° C. for 12 hours, to thereby yield montmorillonite treated with a dodecylammonium ion (organic-treated layered silicate (D4)).

<Preparation of Two-Component Liquid Mixture (D41)>

The organic-treated montmorillonite (organic-treated layered silicate (D4)) (1 part by weight) was added to N,N-dimethylacetamide having an SP value of 10.8 (100 parts by weight), and the resultant mixture was stirred by means of a high-speed homogenizer (product name: Physcotron NS-51, product of Microtec Co., Ltd.) at 10,000 rpm for 20 minutes, to thereby yield an organic-treated montmorillonite dispersion (two-component liquid mixture (D41)). Haze of the two-component liquid mixture was measured by means of a color difference/turbidity meter, and was found to be 65.8%.

The procedure of Example 1 was repeated, except that the polyimide (A1) obtained in Production Example 1 was mixed with the two-component liquid mixture (D41) at 60° C. so that the amount of the organic-treated montmorillonite was 8 parts by weight on the basis of 100 parts by weight of the polyimide, to thereby yield a partially turbid polyimide composite film having a thickness of 105 μm. The ash content of the film was found to be 6.7%. Total light transmittance, haze, glass transition temperature, tensile strength, and moisture permeation coefficient of the film were measured. The results are shown in Table 1.

### Comparative Example 6

The procedure of Example 1 was repeated, except that the polyimide (A2) obtained in Production Example 2 was mixed with the two-component liquid mixture (D41) at 60° C. so that the amount of the organic-treated montmorillonite was 8 parts by weight on the basis of 100 parts by weight of the polyimide, to thereby yield a partially turbid polyimide composite film having a thickness of 108 μm. The ash content of the film was found to be 6.7%. Total light transmittance, haze, glass transition temperature, tensile strength, and moisture permeation coefficient of the film were measured. The results are shown in Table 1.

TABLE 1

| | Polyimide | Acid | | | | | | | Moisture permeation | Tensile | Film |
|---|---|---|---|---|---|---|---|---|---|---|---|
| | synthesis | anhydride | Organic-treated | Organic | Amount | | | | coefficient | strength | thickness |
| Section | process | Diamine | layered silicate | onium ion | (%) | T (%) | H (%) | Tg (° C.) | (g · mm/m2 · day) | (Mpa) | (μm) |
| Ex. 1 | Production | H-PMDA | Montmorillonite | S-204 | 8 | 89.4 | 1.4 | 342 | 3.04 | 136 | 117 |
| | Ex. 1 | ODA | | | | | | | | | |
| Ex. 2 | Production | H-PMDA | Montmorillonite | L-207 | 8 | 89.5 | 1.2 | 340 | 4.41 | 132 | 122 |
| | Ex. 1 | ODA | | | | | | | | | |
| Ex. 3 | Production | H-PMDA | Hectorite | SEN | 15 | 88.9 | 1.3 | 335 | 15.23 | 123 | 112 |
| | Ex. 1 | ODA | | | | | | | | | |
| Comp. | Production | H-PMDA | — | — | — | 89.8 | 0.4 | 310 | 21.76 | 112 | 138 |
| Ex. 1 | Ex. 1 | ODA | | | | | | | | | |
| Comp. | Production | H-PMDA | Montmorillonite | S-204 | 25 | 83.1 | 14.1 | 349 | 2.68 | 108 | 105 |
| Ex. 3 | Ex. 1 | ODA | | | | | | | | | |
| Comp. | Production | H-PMDA | Montmorillonite | Dodecylamine | 8 | 85.8 | 9.1 | 329 | 13.05 | 125 | 105 |
| Ex. 5 | Ex. 1 | ODA | | | | | | | | | |
| Ex. 4 | Production | H-PMDA | Montmorillonite | S-204 | 8 | 89.8 | 1.1 | 320 | — | 106 | 115 |
| | Ex. 2 | DCHM | | | | | | | | | |
| Ex. 5 | Production | H-PMDA | Montmorillonite | L-207 | 8 | 90.1 | 0.9 | 315 | — | 110 | 120 |
| | Ex. 2 | DCHM | | | | | | | | | |
| Ex. 6 | Production | H-PMDA | Hectorite | SEN | 15 | 89.3 | 0.9 | 316 | — | 105 | 116 |
| | Ex. 2 | DCHM | | | | | | | | | |
| Ex. 7 | Production | H-PMDA | Hectorite | SEN | 15 | 89.0 | 1.1 | — | — | — | 110 |
| | Ex. 2 | DCHM | | | | | | | | | |
| Comp. | Production | H-PMDA | — | — | — | 90.5 | 0.3 | 281 | — | 86 | 124 |
| Ex. 2 | Ex. 2 | DCHM | | | | | | | | | |
| Comp. | Production | H-PMDA | Montmorillonite | S-204 | 25 | 83.7 | 13.5 | 322 | — | 78 | 102 |
| Ex. 4 | Ex. 2 | DCHM | | | | | | | | | |
| Comp. | Production | H-PMDA | Montmorillonite | Dodecylamine | 8 | 85.5 | 9.9 | 319 | — | 106 | 108 |
| Ex. 6 | Ex. 2 | DCHM | | | | | | | | | |

H-PMDA: 1,2,4,5-cyclohexanetetracarboxylic dianhydride,
ODA: oxydianiline,
DCHM: 1,4-diaminodicyclohexylmethane,
T: total light transmittance,
H: haze,
Tg: glass transition temperature

1. A colorless, transparent polyimide composite film comprising a polyimide (A) having a repeating unit represented by the following formula (1), and an organic-treated layered silicate (B) obtained through treatment with an organic onium ion represented by the following formula (2) or (3), the organic-treated layered silicate (B) being dispersed in the polyimide (A);
formula (1) being represented by: 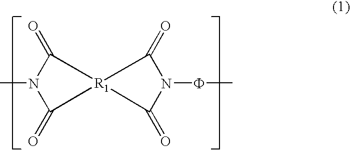
wherein R₁ represents a C5-C16 tetravalent chain or cyclic aliphatic hydrocarbon group; and Φ represents a C2-C28 divalent aliphatic hydrocarbon group or a C6-C27 divalent aromatic hydrocarbon group;
formula (2) being represented by: 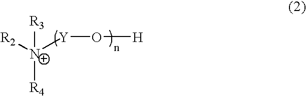
wherein Y represents a C1-C3 alkylene group; R₂, R₃, and R₄ each represent a C1-C18 alkyl group or a hydrogen atom; the total number of carbon atoms of R₂ to R₄ is 10 or more; and n represents an integer of 1 to 25; and
formula (3) being represented by: 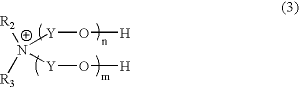
wherein Y represents a C1-C3 alkylene group; R₂ and R₃ each represent a C1-C18 alkyl group or a hydrogen atom; the total number of carbon atoms of R₂ and R₃ is 10 or more; n represents an integer of 1 to 25; m represents an integer of 1 to 25; and n+m is an integer of 2 to 50.

2. A colorless, transparent polyimide composite film according to claim 1, the polyimide (A) being a polyimide having a repeating unit represented by the following formula (4): 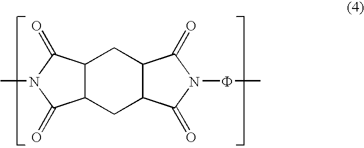
wherein Φ represents a C2-C28 divalent aliphatic hydrocarbon group or a C6-C27 divalent aromatic hydrocarbon group.

3. A colorless, transparent polyimide composite film according to claim 1, which, when having a thickness of 100 μm, exhibits a total light transmittance of 86% or more.

4. A method for producing a colorless, transparent polyimide composite film, the method comprising forming a film-form mixture through extrusion or application, onto a support, of a three-component liquid mixture containing a polyimide (A) having a repeating unit represented by the following formula (1), an organic-treated layered silicate (B) obtained through treatment with an organic onium ion represented by the following formula (2) or (3), and an organic solvent (C) having an SP value of 9.8 to 12.7 and containing at least one structure selected from the group consisting of a cyclic ether, a cyclic ketone, a cyclic ester, an amide, and urea; and subsequently removing the organic solvent (C) from the film-form mixture, the following conditions (I) to (III) being satisfied:
(I) the organic-treated layered silicate (B) is employed in such an amount that a two-component liquid mixture of the organic-treated layered silicate (B) and the organic solvent (C) has a haze of less than 50%;
(II) the amount of the organic-treated layered silicate (B) is 1 part by weight or more and less than 20 parts by weight on the basis of 100 parts by weight of the polyimide (A); and
(III) the organic solvent (C) is employed in such an amount that the amount of the polyimide (A) is 1 part by weight or more on the basis of 100 parts by weight of the organic solvent (C); formula (1) being represented by: 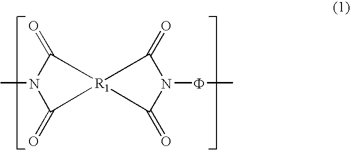
wherein R₁ represents a C5-C16 tetravalent chain or cyclic aliphatic hydrocarbon group; and Φ represents a C2-C28 divalent aliphatic hydrocarbon group or a C6-C27 divalent aromatic hydrocarbon group;
formula (2) being represented by: 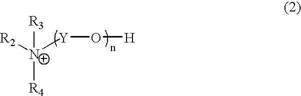
wherein Y represents a C1-C3 alkylene group; R₂, R₃, and R₄ each represent a C1-C18 alkyl group or a hydrogen atom; the total number of carbon atoms of R₂ to R₄ is 10 or more; and n represents an integer of 1 to 25; and
formula (3) being represented by: 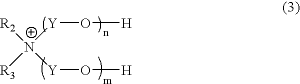
wherein Y represents a C1-C3 alkylene group; R₂ and R₃ each represent a C1-C18 alkyl group or a hydrogen atom; the total number of carbon atoms of R₂ and R₃ is 10 or more; n represents an integer of 1 to 25; m represents an integer of 1 to 25; and n+m is an integer of 2 to 50.

5. A method for producing a colorless, transparent polyimide composite film according to claim 4, wherein the three-component liquid mixture is prepared by mixing a mixture containing the polyimide (A) and the organic solvent (C) with the organic-treated layered silicate (B).

6. A method for producing a colorless, transparent polyimide composite film according to claim 4, wherein the three-component liquid mixture is prepared by mixing the polyimide (A) with a mixture containing the organic-treated layered silicate (B) and the organic solvent (C).

7. A method for producing a colorless, transparent polyimide composite film according to claim 4, wherein the three-component liquid mixture is prepared by mixing a mixture containing the polyimide (A) and a portion of the organic solvent (C) with a mixture containing the organic-treated layered silicate (B) and a portion of the organic solvent (C).

8. A method for producing a colorless, transparent polyimide composite film according to claim 4, the polyimide (A) being a polyimide having a repeating unit represented by the following formula (4): 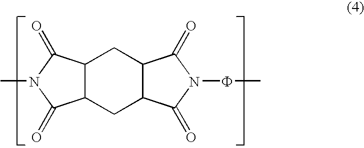
wherein Φ represents a C2-C28 divalent aliphatic hydrocarbon group or a C6-C27 divalent aromatic hydrocarbon group.

9. A method for producing a colorless, transparent polyimide composite film according to claim 4, wherein, when having a thickness of 100 μm, the film exhibits a total light transmittance of 86% or more.

10. A method for producing a colorless, transparent polyimide composite film according to claim 4, wherein the organic solvent is one or more species selected from the group consisting of γ-butyrolactone, N,N-dimethylacetamide, N,N-dimethylformamide, and N-methyl-2-pyrrolidone.
